(19) United States
(12) Patent Application Publication
(10) Pub. No.: US 2004/0055987 A1
(43) Pub. Date: Mar. 25, 2004

(54) Medi-nipple

(76) Inventor: Regina Gale Paige, Mesquite, TX (US)

Correspondence Address: Regina Gale Paige, LVN, 3306 Point East Dr., Mesquite, TX, 75150, US

(21) Appl. No.: 10/252,926

(22) Filed: Sep. 24, 2002

(51) Int. Cl. B65D 85/00; A61J 9/00; A61J 11/00

(52) U.S. Cl. 215/11.1; 215/365

(57) ABSTRACT

The Medi-Nipple is a liquid medication dispenser that is comprised of a rim-lid unit, with a tab lock that prevents the medicine from leaking out, and a clear nipple with CC (cubic centimeter) markings for dosage levels.

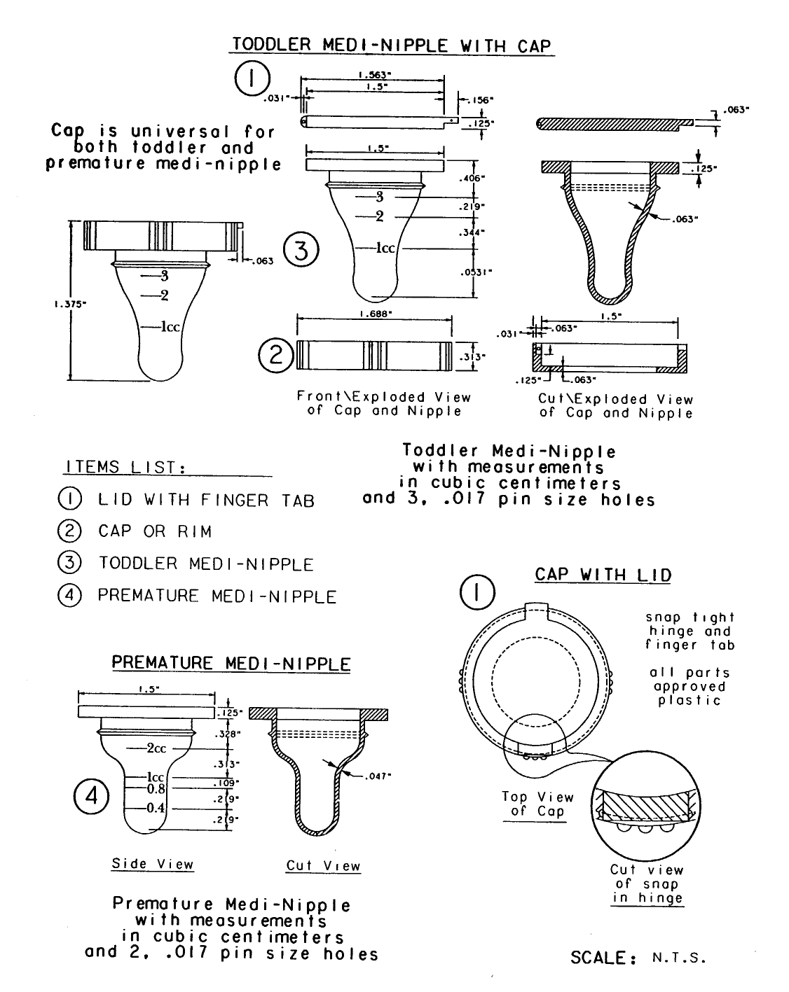

### DETAILED DESCRIPTION

The Medi-Nipple

A liquid medication nipple made of clear plastic (silicone) and black non-toxic markings of CC's(cubic centimeters) the current established dosages prescribed by doctors and medical professionals. The Medi-Nipple is easy enough for any caregiver to use in a non-threatening and easy way. The nipple comprises the snap tab that encloses the rim and the nipple. The tab seals and secures the contents to prevent leaking and miscalculations of dosages.

This product will contain the lid, rim and nipple. These three parts will help eliminate multiple steps of assembly, ie- nipple, bottle, rim, syringe. The fewer steps involved the less of chance of errors.

The rim consist of hardened and durable plastic. There is a premature nipple. The premature nipple is for babies less than 34 weeks. The hole in the premature nipple is bigger to facilitate the flow of medicine due to their poor sucking reflex.

The lid is a “flip-top” mechanisim made from the same material as the rim. The nipple will be clear, made of silicone, with permanent black, non-toxic ink markings in CC's.(cubic centimeters) Black markings are prefered due to medications being produced in multi-colors; thus eliminating possible mistakes. Chemotherapy is contra-indicated. The chemicals will be corrosive and able to be in direct contact with the mucous membranes of the mouth and throat. The size of the hole in the nipples will be different on the premature and the toddler size.

The toddler nipple has the same components- the rim, lid and the nipple. It is for the baby over 40 weeks. It has the same functions, (clear silicone, CC markings) except the hole will not be as large as the hole in the premature nipple.

I. When assembled the device creates a closed container with a perforated nipple, silicone mounted, in a plastic, snap-on retainer ring and nipple cap.. When filled, the liquid passes through a perforation made at the apex of the nipple by a puncture with an 18 gauge surgical needle. The lid, when placed over the proximal end of the nipple and inserted into the nipple ring, creates an enclosed, circumferential, liquid tight, sealed container. Imprinted upon the nipple is a graduated scale, depicting by volume, in cubic centimeters the amount of liquid contained therein.

II. A closure-assembly as set forth in claim 1., wherein one of the normally interengaged surfaces of the nipple and lid respective is substantially conical to present a flat face, with coaxial retaining ring rim with the member of said retaining ring of sufficient diameter to cause the seal affected between the nipple and lid and said segment to become tighter as the ring in compressed thereon.

III. A closure assembly as set forth in claim II. Wherein said interior coaxial surface of the ring of the retainer is provided with a continuous annular rib half-way integral with the normally upper edge there of and defining said segment and said rib having an outwardly facing. Inclined surface presenting said conical of greatest external diameter at the zone of juncture of the rib with the retainer, said member having single of inner, coaxial, longitudinally spaced, then cylindrical surface and presenting said rib there between lying in a plane perpendicular to the axis of said cylindrical surface, the diameter of said innermost cylindrical surface of the member being intermediate to the diameter of opposed external in margins of said rib.

IV. A closure assembly as set forth in claim III. Wherein the member and retainer are constructed of materials having different coefficients of hardness whereby one of the interengaged faces of the rib and said shoulder respectively is deformed as the member is compressed toward the cap to thereby produce a more effective seal therebetween.
